(19) United States
(12) Patent Application Publication
(10) Pub. No.: US 2014/0152127 A1
(43) Pub. Date: Jun. 5, 2014

(54) STATOR FOR BRUSHLESS EXTERNAL-ROTOR MOTOR AND METHOD OF MANUFACTURING THEREOF

(71) Applicant: ZHONGSHAN BROAD-OCEAN MOTOR CO., LTD, Zhongshan (CN)

(72) Inventors: Songfa TANG, Zhongshan (CN); Jianwei JIN, Zhongshan (CN)

(73) Assignee: ZHONGSHAN BROAD-OCEAN MOTOR CO., LTD., Zhongshan (CN)

(21) Appl. No.: 13/844,983

(22) Filed: Mar. 17, 2013

(30) Foreign Application Priority Data
Nov. 30, 2012 (CN) 201210505002.7

(51) Int. Cl. H02K 1/14; H02K 1/02; H02K 15/02

(52) U.S. Cl. CPC H02K 1/148; H02K 15/022; H02K 1/02
USPC 310/43; 310/216.086; 29/596; 310/44

(57) ABSTRACT

A stator for a brushless external-rotor motor. The stator includes a stator core; a winding; and an end insulator. The stator core includes a yoke part and a tooth part which are separated. The tooth part includes a clamping part. The tooth part is formed by overlapping a plurality of silicon-steel sheets. The end insulator is sleeved on the tooth part. The winding is wound on the end insulator. The yoke part is formed by molding permeability magnetic material and includes a mounting hole in a center. A plurality of lug bosses protrudes at intervals on an outer side of the yoke par. A clamping groove is formed between two connected lug bosses. The clamping part of the tooth part is nested in the clamping groove.

### CROSS-REFERENCE TO RELATED APPLICATIONS

Pursuant to 35 U.S.C. §119 and the Paris Convention Treaty, this application claims the benefit of Chinese Patent Application No. 201210505002.7 filed Nov. 30, 2012, the contents of which are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a stator for a brushless external-rotor motor and manufacturing method thereof.

2. Description of the Related Art

The traditional stator core component for a brushless external-rotor motor is generally formed by overlapping silicon-steel sheets and then winding the overlapped silicon-steel sheets. The technology has the defects of slow winding, difficulty in embedding and more waste in cores, thus the cost is relatively high, the production efficiency is low, the integrity is poor, and the protection and insulation to windings are also relatively poorer.

### SUMMARY OF THE INVENTION

In view of the above-described problems, it is one objective of the invention to provide a stator for a brushless external-rotor motor. The stator for a brushless external-rotor motor has the advantages of easiness in winding, saved material, reduced cost, good integrity and better protection and insulation to windings.

To achieve the above objective, in accordance with one embodiment of the invention, there is provided a stator for a brushless external-rotor motor, comprising: a stator core, the stator core comprising a yoke part and a tooth part which are separated, the tooth part comprising a clamping part; a winding; and an end insulator. The tooth part is formed by overlapping a plurality of silicon-steel sheets. The end insulator is sleeved on the tooth part. The winding is wound on the end insulator. The yoke part is formed by molding permeability magnetic material and comprises a mounting hole in a center. A plurality of lug bosses protrudes at intervals on an outer side of the yoke par. A clamping groove is formed between two connected lug bosses. The clamping part of the tooth part is nested in the clamping groove.

In a class of this embodiment, the stator core, the winding, and the end insulator are clad with an injection mold.

In a class of this embodiment, the permeability magnetic material adopts sendust material.

In a class of this embodiment, the clamping part is a dovetail lug boss, and the clamping groove is a dovetail groove.

In a class of this embodiment, the injection mold comprises an upper end plate and a lower end plate which are positioned at two ends of the stator core respectively, and a connecting column, the connecting column is connected with the upper end plate and the lower end plate.

In a class of this embodiment, a plurality of through holes is circumferentially formed on the yoke part, and one part of the connecting column penetrates the through holes.

In a class of this embodiment, the other part of the connecting column is positioned outside the lug bosses.

In a class of this embodiment, the tooth part comprises a tooth crown on an outer side, and the tooth crown is exposed out of the injection mold.

Compared with the prior art, the stator for a brushless external-rotor motor has the benefits that: (1) the stator core comprises a yoke part and a tooth part which are separated, the tooth part is formed by overlapping a plurality of silicon-steel sheets, the yoke part is formed by molding permeability magnetic material, a mounting hole is formed in the center of the yoke part, the yoke part is clamped with the tooth part, there is no material waste in the manufacture of the yoke part, the tooth part has a simple structure and small volume, thus the material waste in the stamping process is reduced to the utmost extent, the manufacturing cost of the stator core is reduced, after calculation, compared with the traditional core formed by integral stamping and overlapping, the cost of the stator core manufactured in this invention is reduced by 15%-30%, and the processing and the winding are convenient; (2) the stator core, winding and end insulator are clad with an injection mold, thus the integrity is strong, and the stator for a brushless external-rotor motor has the functions of waterproof and impact-proof protection.

In another aspect, the invention provides a method for manufacturing the stator for a brushless external-rotor motor, the method comprising the following steps:
a) manufacturing stamped silicon-steel sheets according to the shape of the tooth part, and overlapping the silicon-steel sheets into the tooth part;
b) sleeving the end insulator outside the tooth part, and winding the winding on the end insulator;
c) according to the shape of the yoke part, molding the yoke part with sendust permeability magnetic material;
d) nesting a plurality of tooth parts installed with the end insulator and the winding on the outer side of the yoke part; and
e) integrating the end insulator, the winding, the tooth part, and the yoke part by injection-molding

Compared with the prior art, the manufacturing method of the motor stator has the benefits that: (1) the stator core comprises a yoke part and a tooth part which are separated, wherein the tooth part is formed by overlapping a plurality of silicon-steel sheets, the yoke part is formed by molding permeability magnetic material, thus the scrap waste in the stamping process is reduced, and the cost is reduced; (2) the tooth part is separated, so as to be convenient for winding, thus the process is simple, and the production efficiency is improved; (3) the end insulator, winding, tooth part and yoke part are formed into a whole by injection molding, thus the integrity is good, the large-scale production is favorable, and the waterproof and impact-proof protection functions are good.

### BRIEF DESCRIPTION OF THE DRAWINGS

FIG. 1 is a plane diagram of installation of a yoke part and a tooth part of a stator core;

FIG. 2 is a three-dimensional diagram of a wound tooth part of the stator core;

FIG. 3 is an assembly diagram of a stator core;

FIG. 4 is a three-dimensional diagram of an injection-molded stator for a brushless external-rotor motor;

FIG. 5 is a front view of an injection-molded stator for a brushless external-rotor motor;

FIG. 6 is an A-A cutaway view of FIG. 5; and

FIG. 7 is a B-B cutaway view of FIG. 5.

### DETAILED DESCRIPTION OF THE EMBODIMENTS

The following specific embodiments and drawings aim to serve as the further description for the stator for a brushless external-rotor motor.

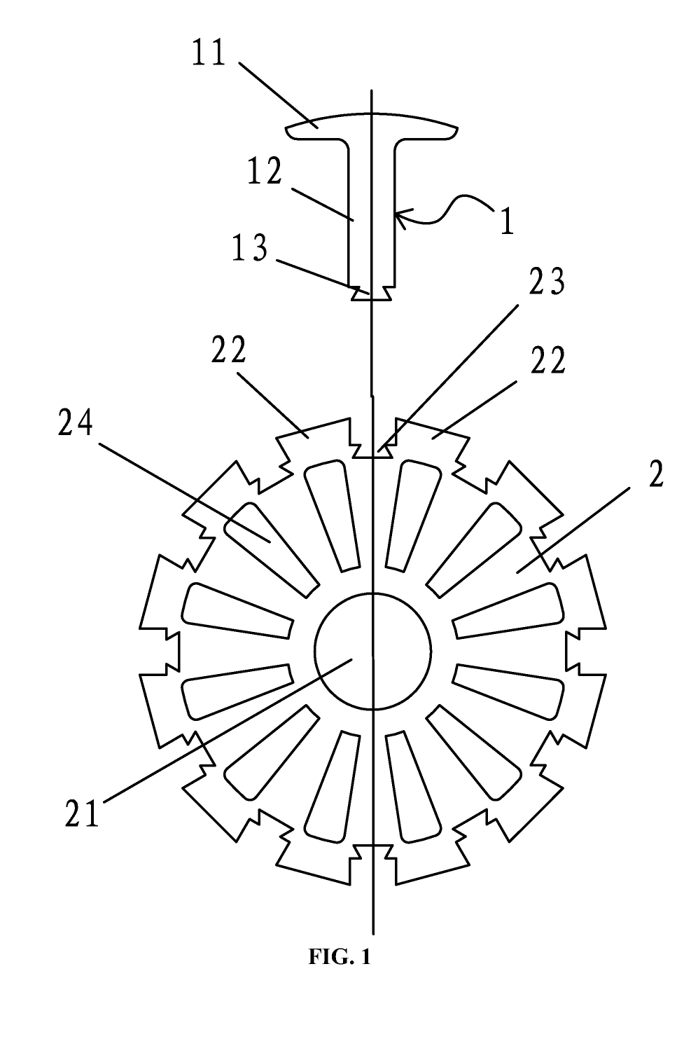

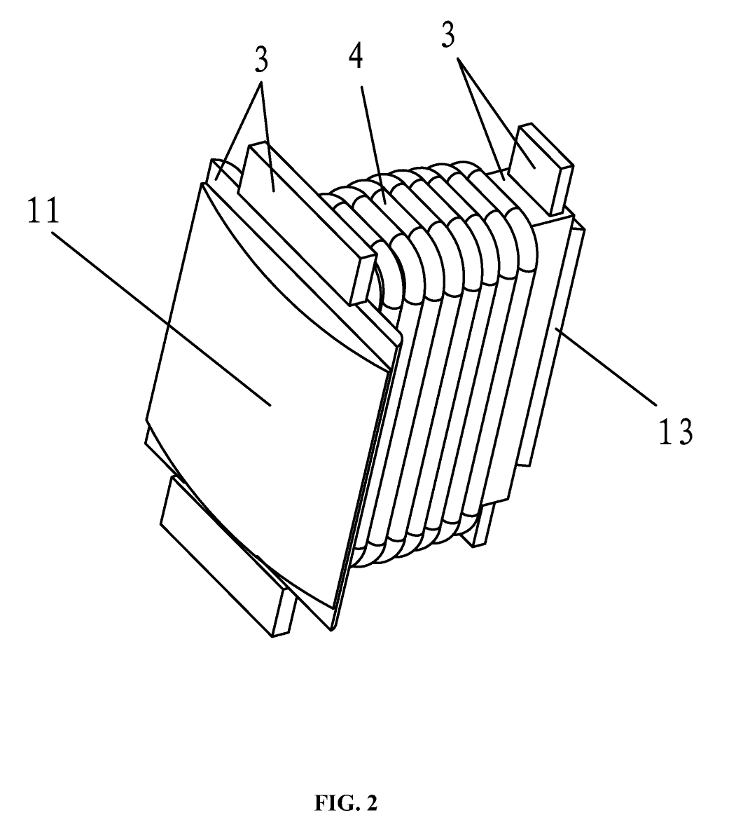

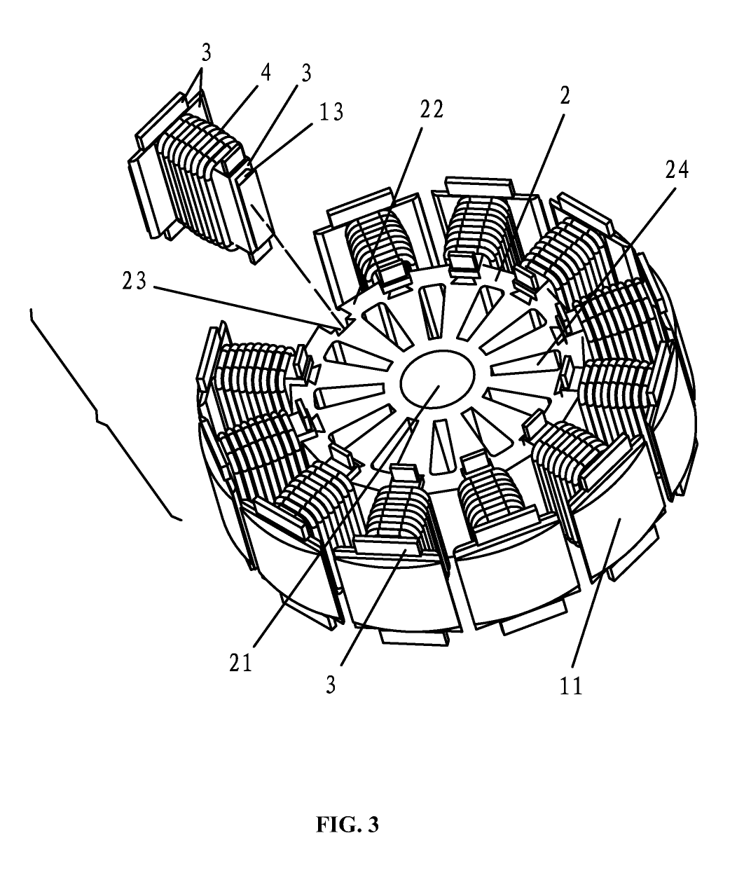

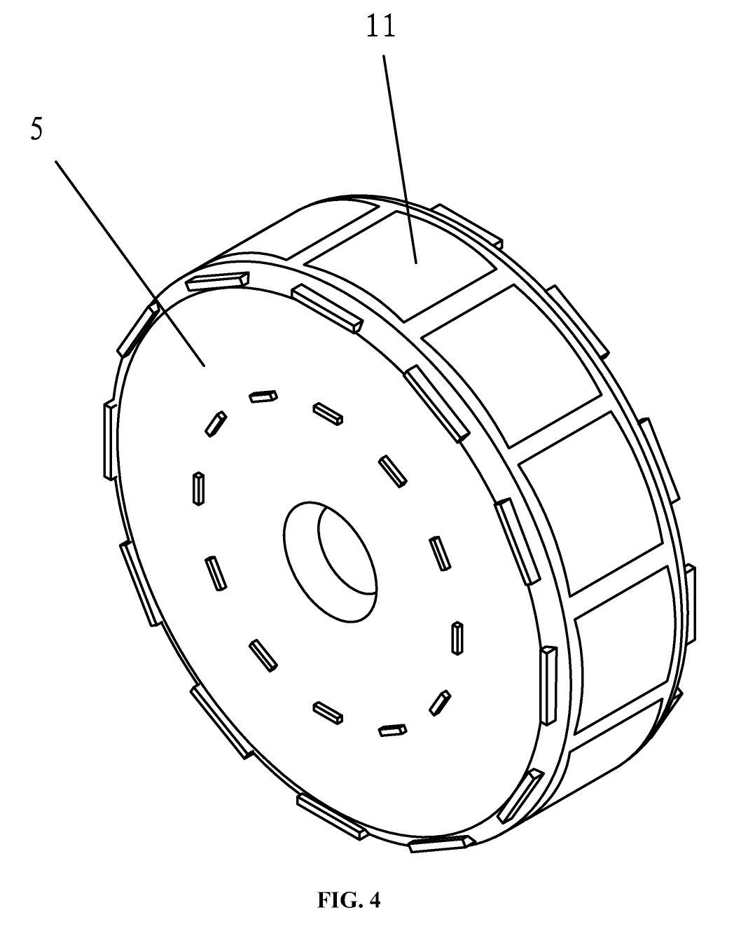

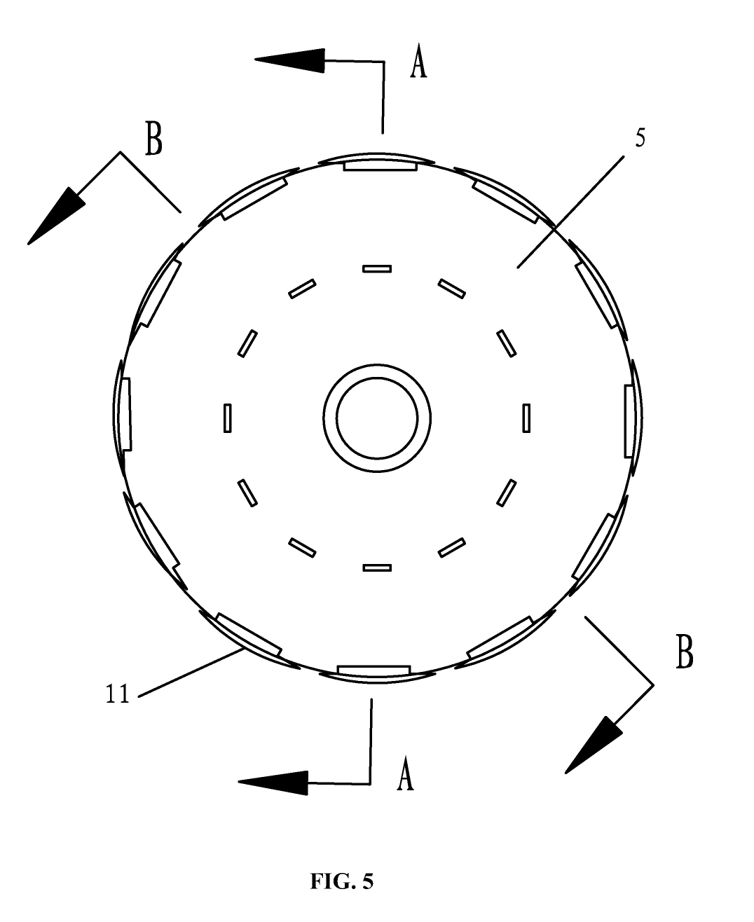

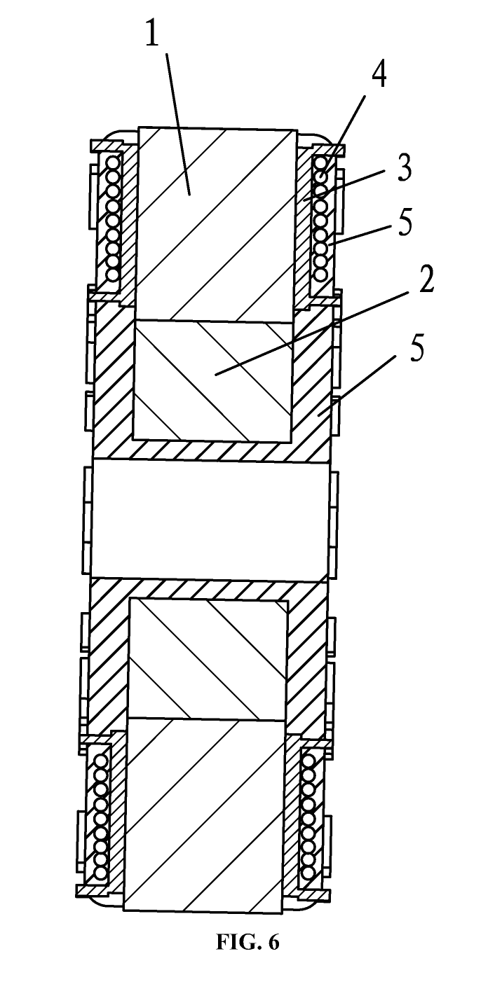

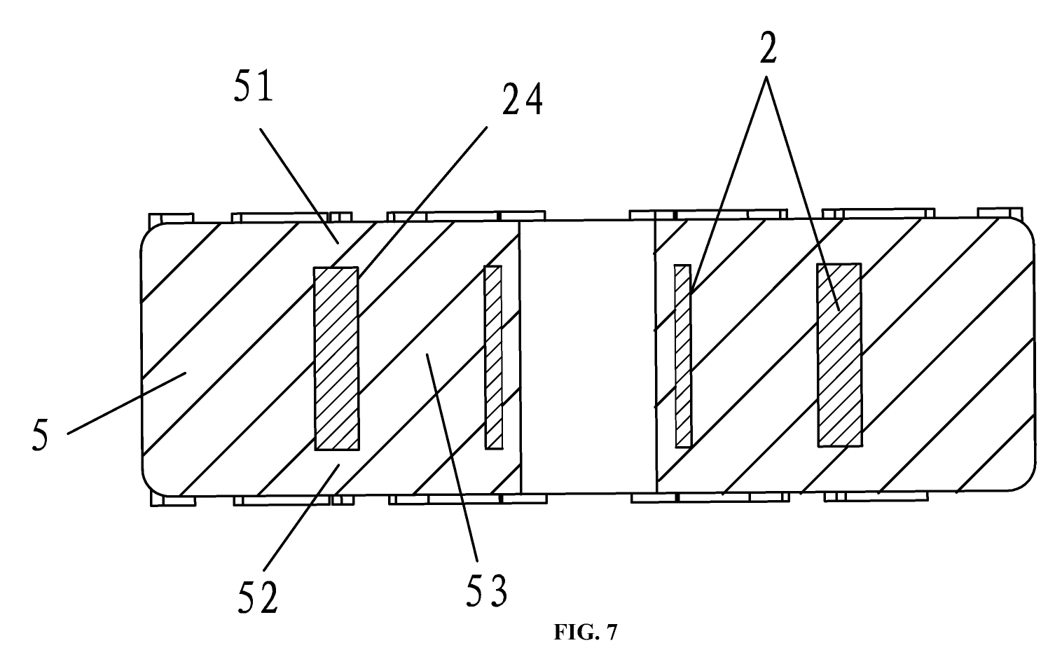

As shown in FIGS. 1-7, a stator for a brushless external-rotor motor comprises a stator core, a winding 3 and an end insulator 4. The stator core comprises a yoke part 2 and a tooth part 1 which are separated. The tooth part 1 is formed by overlapping a plurality of silicon-steel sheets and comprises a tooth crown 11, a tooth root part 12 and a clamping part 13. The end insulator 4 is sleeved on the tooth root part 12. The winding 3 is wound on the end insulator 4. The end insulator 4 is arranged at the clamping part 13 in a protruding manner, and the clamping part 13 is formed at the tail part of the tooth part 1. The yoke part 2 is formed by molding permeability magnetic material. A mounting hole 21 is formed in the center of the yoke part. A plurality of lug bosses 22 protrudes at intervals on the outer side of the yoke part 2. A clamping groove 23 is formed between two connected lug bosses 22. The clamping part 13 of the tooth part 1 is nested in the clamping groove 23. The stator core, the winding 3 and the end insulator 4 are clad with an injection mold 5. The permeability magnetic material used for forming the yoke part 2 adopts sendust material. The clamping part 13 is a dovetail lug boss. The clamping groove 23 is a dovetail groove. The injection mold 5 comprises an upper end plate 51 and a lower end plate 52 which are positioned at two ends of the stator core respectively, and a connecting column 53. The connecting column 53 is connected with the upper end plate 51 and the lower end plate 52. A plurality of through holes 24 is circumferentially formed on the yoke part 2, one part of the connecting column 53 penetrates the through holes 24, and the other part is positioned outside the lug bosses 22. The tooth part 1 comprises a tooth crown 11 on an outer side, and the tooth crown is exposed out of the injection mold 5.

The method for manufacturing the stator for a brushless external-rotor motor comprises the following steps:
(A1) manufacturing a certain amount of stamped silicon-steel sheets according to the shape of the tooth part 1, and overlapping the silicon-steel sheets into the tooth part 1;
(A2) sleeving the end insulator 4 outside the tooth part 1, and then winding the winding 3 on the end insulator 4;
(A3) according to the shape of the yoke part 2, molding the yoke part 2 with sendust permeability magnetic material;
(A4) nesting a plurality of tooth parts 1 installed with the end insulator 4 and the winding 3 on the outer side of the yoke part 2;
(A5) integrating the end insulator 4, the winding 3, the tooth part 1, and the yoke part 2 by injection-molding.

The stator core comprises a yoke part 2 and a tooth part 1 which are separated. The tooth part 1 is formed by a plurality of silicon-steel sheets. The yoke part 2 is formed by molding permeability magnetic material. A mounting hole 21 is formed in the center of the yoke part 2. The yoke part 2 is clamped with the tooth part 1. There is no material waste in the manufacture of the yoke part. The tooth part has a simple structure and small volume. Therefore, the material waste in the stamping process is reduced to the utmost extent. The manufacturing cost of the stator core is reduced, after calculation, compared with the traditional core formed by integral stamping and overlapping, the cost of the stator core manufactured in this invention is reduced by 15%-30%, and the processing and the winding are convenient.

The invention claimed is:

1. A stator, comprising:
a) a stator core, the stator core comprising a yoke part and a tooth part which are separated, the tooth part comprising a clamping part;
b) a winding; and
c) an end insulator;
wherein
the tooth part is formed by overlapping a plurality of silicon-steel sheets;
the end insulator is sleeved on the tooth part;
the winding is wound on the end insulator;
the yoke part is formed by molding permeability magnetic material and comprises a mounting hole in a center;
a plurality of lug bosses protrudes at intervals on an outer side of the yoke part;
a clamping groove is formed between two connected lug bosses; and
the clamping part of the tooth part is nested in the clamping groove.

2. The stator of claim 1, wherein the stator core, the winding, and the end insulator are clad with an injection mold.

3. The stator of claim 1, wherein the permeability magnetic material adopts sendust material.

4. The stator of claim 2, wherein the permeability magnetic material adopts sendust material.

5. The stator of claim 3, wherein the clamping part is a dovetail lug boss, and the clamping groove is a dovetail groove.

6. The stator of claim 4, wherein the clamping part is a dovetail lug boss, and the clamping groove is a dovetail groove.

7. The stator of claim 2, wherein the injection mold comprises an upper end plate and a lower end plate which are positioned at two ends of the stator core respectively, and a connecting column, the connecting column is connected with the upper end plate and the lower end plate.

8. The stator of claim 7, wherein a plurality of through holes is circumferentially formed on the yoke part, and one part of the connecting column penetrates the through holes.

9. The stator of claim 8, wherein the other part of the connecting column is positioned outside the lug bosses.

10. The stator of claim 2, wherein the tooth part comprises a tooth crown on an outer side, and the tooth crown is exposed out of the injection mold.

11. A method for manufacturing a stator for a brushless external-rotor motor of claim 1, the method comprising the following steps:
a) manufacturing stamped silicon-steel sheets according to a shape of the tooth part, and overlapping the silicon-steel sheets into the tooth part;
b) sleeving the end insulator outside the tooth part, and winding the winding on the end insulator;
c) molding the yoke part with sendust permeability magnetic material according to a shape of the yoke part;
d) nesting a plurality of tooth parts installed with the end insulator and the winding on the outer side of the yoke part; and
e) integrating the end insulator, the winding, the tooth part, and the yoke part by injection-molding.
